(19) United States
(12) Patent Application Publication
(10) Pub. No.: US 2023/0345951 A1
(43) Pub. Date: Nov. 2, 2023

(54) EDIBLE FOOD WRAP COMPOSITION

(71) Applicant: Cargill, Incorporated, Wayzata, MN (US)

(72) Inventors: Elizabeth Barlow, St. Michael, MN (US); Jonathan Mark Griebel, Maple Grove, MN (US)

(73) Assignee: Cargill, Incorporated, Wayzata, MN (US)

(21) Appl. No.: 18/042,654

(22) PCT Filed: Aug. 25, 2021
(86) PCT No.: PCT/US2021/047565

§ 371 Date: Feb. 23, 2023

Related U.S. Application Data
(60) Provisional application No. 63/070,588, filed on Aug. 26, 2020.

(51) Int. Cl. A21D 13/066; A21D 13/04; A21D 13/42; A21D 13/32; A21D 2/26; A23L 15/10; A21D 2/18

(52) U.S. Cl. CPC A21D 13/066; A21D 13/04; A21D 13/42; A21D 13/32; A21D 2/262; A23L 15/10; A21D 2/186

(57) ABSTRACT

This disclosure relates to a composition useful for making edible food carriers and food carriers made therefrom. In an aspect, the composition is gluten-free. In an aspect, the composition is higher in protein and lower in carbohydrate than traditional food carriers. In an aspect, the composition contains egg whites. In an aspect, the composition may also contain one or more plant protein ingredients.

### CROSS-REFERENCE TO RELATED APPLICATIONS

This application claims the benefit of U.S. Provisional Patent Application No. 63/070,588, filed 26 Aug. 2020, which is hereby incorporated by reference in its entirety.

### BACKGROUND

Sandwich wrap shells, tortillas, soft taco shells and similar food products are typically made from wheat or corn flour. Such food products are relatively low in protein content and may contain allergens such as gluten. There is a need for a composition for making edible food carriers that are high in protein content and gluten-free.

### SUMMARY

The present disclosure relates to a composition useful for making edible food carriers and food carriers made therefrom. In an aspect, the composition is a composition for making edible food carriers, comprising or consisting of: egg whites in an amount of at least 85% by weight; one or more plant protein ingredients in an amount of at least 3% by weight; vegetable oil; and a stabilizer. In an aspect, the composition is a composition for making edible food carriers, comprising or consisting of: egg whites in an amount of at least 80% by weight; water; starch; salt and a stabilizer.

In an aspect, the one or more plant protein ingredients comprises pea protein. In an aspect, the one or more plant protein ingredients comprises a pea protein isolate or concentrate having at least 70%, at least 75%, or at least 80% by weight pea protein. In an aspect, the egg whites are present in an amount of at least 90% by weight. In an aspect, the one or more plant protein ingredients are present in an amount of at least 4%, at least 5%, or at least 5.5% by weight.

In an aspect, the composition is a composition for making edible food carriers, comprising: egg in an amount of at least 60% by weight; one or more non-meat protein ingredients in an amount of at least 5% by weight; vegetable oil; and a stabilizer.

In an aspect, the composition further comprises water. In an aspect, the one or more non-meat protein ingredients comprises a dairy ingredient. In an aspect, the dairy ingredient comprises cultured skim milk.

In an aspect, the one or more non-meat protein ingredients comprises one or more plant protein ingredients. In an aspect, the one or more plant protein ingredients comprise pea protein, quinoa protein, buckwheat protein, or any combination thereof.

In an aspect, the egg is present in an amount of at least 65%, at least 67%, at least 69%, or at least 70% by weight. In an aspect, the one or more non-meat protein ingredients are present in an amount of at least 7%, at least 10%, at least 12%, at least 14%, at least 15%, at least 17%, at least 18%, or at least 19% by weight. In an aspect, the vegetable oil is olive oil or soybean oil. In aspect, the vegetable oil is present in an amount of at least 0.5%, at least 1%, or at least 2% by weight.

In an aspect, the stabilizer is xanthan gum. In an aspect, the stabilizer is psyllium fiber. In an aspect, the composition further comprises salt. In an aspect, the composition further comprises a native starch. In an aspect, the composition further comprises one or more flavor ingredients.

In an aspect, the composition or food carrier is gluten-free. In an aspect, the compositions or food carrier is low in carbohydrates or substantially free of carbohydrate. In an aspect, the compositions or food carrier have a total carbohydrate content of less than 2% by weight, less than 1% by weight, less than 0.5% by weight, or less than 0.1% by weight.

### BRIEF DESCRIPTION OF THE FIGURES

The drawings illustrate generally, by way of example, but not by way of limitation, various embodiments discussed in the present document.

FIG. 1 is a photo image of an edible food carrier made from a composition described herein.

FIG. 2 is a photo image of an edible food carrier made from a composition described herein that includes a flavor ingredient.

FIG. 3 is a photo image of an edible food carrier made from a composition described herein that has been used to wrap a food filling.

### DETAILED DESCRIPTION

Disclosed herein are edible food wrap compositions based on a combination of egg and non-meat protein. In an aspect, the compositions are substantially free of gluten or gluten-free. The composition can be used to make edible food carriers such as tortillas, soft taco shells, sandwich wrap shells, pancakes, crepes, and the like, that are higher in protein and lower in carbohydrate than food carriers made from traditional flours, such as corn or wheat flour. Food carriers made from the composition(s) described herein perform well compared to currently available food carriers in both taste and texture.

Unless defined otherwise, all technical and scientific terms used herein have the same meaning as commonly understood by one skilled in the art to which this invention belongs. As used herein, each of the following terms has the meaning associated with it as defined below.

As used herein, “egg” refers primarily to chicken eggs, but can include any type of avian egg, and can refer to whole eggs, egg whites, and/or egg yolks.

The terms “edible food carrier,” food carrier,” “edible food wrap,” and “food wrap” are used interchangeably herein and refer to any edible carrier or shell useful for wrapping food materials.

As used herein, the terms “non-meat protein” and “non-meat protein ingredient” refer to a composition that contains a significant amount of protein, but does not contain any protein derived from animal muscle. Non-limiting examples of non-meat protein include protein compositions derived from plant sources and dairy sources.

As used herein, “dairy protein ingredient” refers to a composition sourced from dairy that contains a significant amount of protein. Non-limiting examples of dairy protein ingredients include cheese, milk, and compositions derived from cheese and milk. Dairy protein ingredients can be derived from the milk of cows, sheep, goats, or any other suitable animal.

As used herein, “plant protein ingredient” refers to a composition sourced from plants that contains a significant amount of plant protein. As would be understood by a person skilled in the art, a plant protein ingredient generally contains other components aside from protein, such as starch and/or other carbohydrates, fat, and fiber. Preferred plant protein ingredients are ingredients sourced from plants that are enriched in protein, i.e., have a higher protein content than is typically found in the natural plant source. It is to be understood that this definition applies to specific plant protein ingredients such pea protein ingredient, rice protein ingredient, etc.

In an aspect, the food wrap composition comprises egg, non-meat protein ingredient(s), salt, vegetable oil, and a stabilizer. The non-meat protein ingredient can be a plant protein ingredient, a dairy protein ingredient, or a mixture thereof.

In an aspect, the plant protein ingredient is a pea protein isolate or concentrate. In an aspect, the pea protein isolate or concentrate is at least 70, 75, or 80 wt % pea protein. In an aspect, the plant protein ingredient is quinoa flour. In an aspect, the plant protein ingredient is buckwheat flour.

In an aspect, the food wrap composition comprises egg, starch, e.g., corn starch, salt, and a stabilizer.

In an aspect, the egg comprises only egg whites. In an aspect, the vegetable oil is olive oil. In an aspect, the vegetable oil is soybean oil. In an aspect, the stabilizer is xanthan gum. Other gums may be suitable for use as the stabilizer in the food wrap composition, including but not limited to carrageenan or guar gum. In an aspect, the stabilizer is psyllium fiber.

In an aspect, the salt is sea salt. In an aspect, the salt is present in the food wrap composition in amounts (by weight) of less than 1%, less than 0.8%; less than 0.5%; less than 0.1%; 0.1 to 1%; 0.1 to 0.5%; 0.2 to 0.4%; 0.1 to 0.8%; 0.4 to 0.6%; or 0.5 to 0.9%.

In an aspect, the food wrap composition comprises at least 80, 85, 90, or 91 wt % egg whites and at least 2, 2.5, 3, 3.5, 4, 4.5, 5, 5.5, 6, 6.5, 7, 7.5, 8, 8.5, 9, 9.5, or 10 wt % of one or more non-meat protein ingredients (total amount of all non-meat protein ingredients). This food wrap composition may further comprise vegetable oil, salt, and/or a stabilizer as described elsewhere herein.

In an aspect, the food wrap composition comprises at least 60, 65, or 70 wt % egg and at least 5, 6, 7, 8, 9, 10, 11, 12, 13, 14, 15, 16, 17, 18, 19, or 20 wt % of one or more non-meat ingredients (total amount of all non-meat protein ingredients). This food wrap composition may further comprise vegetable oil, salt, and/or a stabilizer as described elsewhere herein.

The food wrap composition may further comprise vegetable oil, salt, and/or a stabilizer. The food wrap composition may further comprise added water. The food wrap composition may also further comprise a starch or native starch, for example native tapioca starch or corn starch. The food wrap composition may also further comprise one or more flavoring ingredients. If the food wrap composition includes one or more flavoring ingredients, the amount of egg and non-meat protein ingredient(s) as described above are calculated without including the one or more flavoring ingredients.

In an aspect, no additional water needs to be added to the food wrap composition other than the water that is included in the ingredients described herein. As would be understood by a person skilled in the art, eggs or egg whites alone can include all of the water necessary for forming a batter with the food wrap composition described herein.

In an aspect, the food wrap composition comprises a base mix consisting of egg whites, one or more non-meat protein ingredients, salt, vegetable oil, and a stabilizer. In such an aspect, the non-meat protein ingredient can be a pea protein ingredient. In such an aspect, the food wrap composition may further include one or more flavor ingredients.

In an aspect, the food wrap composition comprises a base mix consisting of egg, one or more non-meat protein ingredients, salt, water, vegetable oil, and a stabilizer. In such an aspect, the food wrap composition may further include one or more flavor ingredients.

In an aspect, the food wrap composition consists of or consists essentially of egg, water, starch, salt, and a stabilizer. In an aspect, the food wrap composition consists of or consists essentially of egg whites, water starch, salt, and a stabilizer. In an aspect, the food wrap composition consists of or consists essentially of at least 80% egg whites by weight; 5 to 15% water by weight; 0.1 to 2.0% starch by weight; salt; and 0.1 to 2.0% stabilizer by weight. In an aspect, the starch is corn starch. In an aspect, the stabilizer is psyllium fiber. In an aspect, the food wrap composition consists of or consists essentially of 85 to 90% egg whites by weight; 8 to 12% water by weight; 0.5 to 1.5% starch by weight; 0.1 to 0.5% salt by weight; and 0.5 to 1.5% psyllium fiber by weight.

In an aspect, the food wrap compositions described herein are low in carbohydrates. In an aspect, the food wrap composition has a total carbohydrate content of less than 2% by weight, less than 1% by weight, less than 0.5% by weight, or less than 0.1% by weight. In an aspect, the food wrap composition is substantially free of carbohydrate.

In an aspect, the food wrap composition consists of or consists essentially of egg, a non-meat protein ingredient, salt, vegetable oil, and a stabilizer.

The food wrap composition(s) described herein can be used to make an edible food carrier. Edible food carriers can be made from the compositions by blending the ingredients of the food composition and baking or cooking the blended ingredients using an oven or other suitable method.

### EXAMPLES

The invention is further described in detail by reference to the following experimental examples. These examples are provided for purposes of illustration only and are not intended to be limiting unless otherwise specified. Thus, the invention should in no way be construed as being limited to the following examples, but rather should be construed to encompass any and all variations which become evident as a result of the teaching provided herein.

### Example 1: Food Wrap Based on Egg Whites and Pea Protein

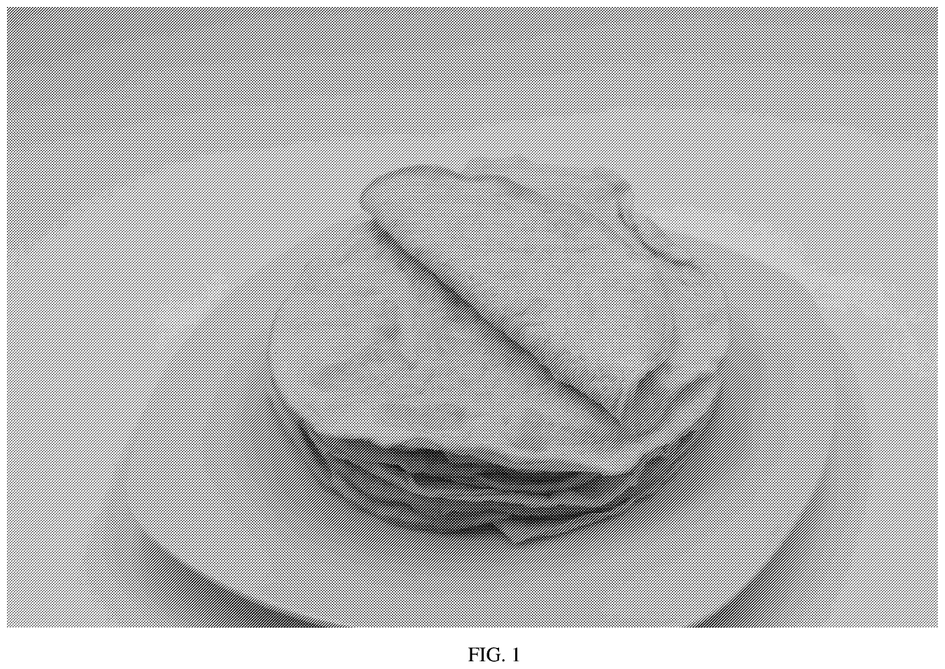

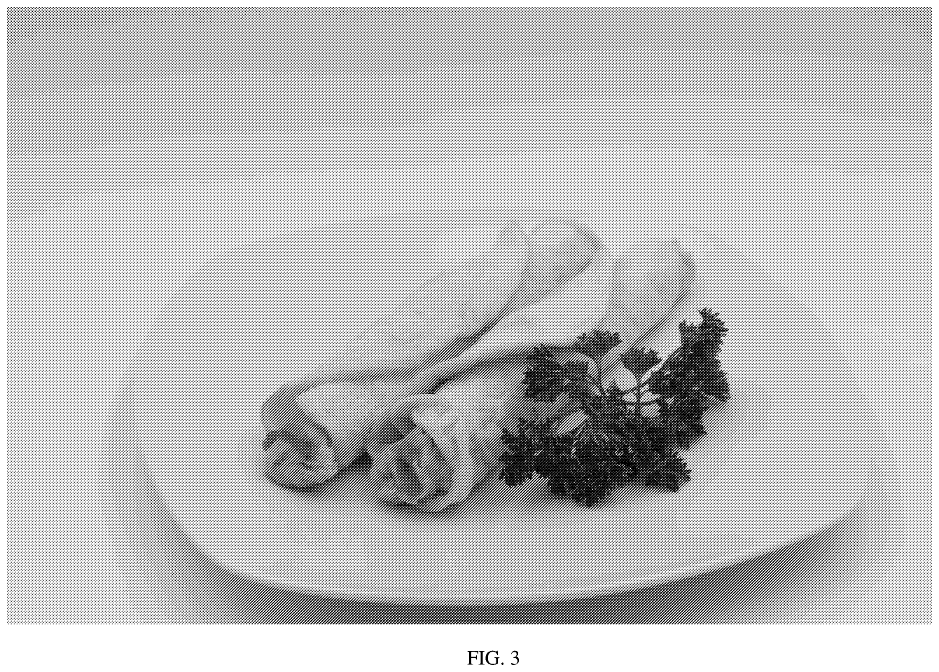

In this example, a food wrap (i.e., edible food carrier) is prepared according to the base formula provided in Table 1 below. Three food wraps were made: one food wrap was made only with the base formula (FIGS. 1 and 3), while two other food wraps further include flavor ingredients as described below.

TABLE 1
Base formula for food wrap

| Ingredient | Amount (%) |
|---|---|
| Egg whites | 91.2 |
| PURIS ™ Pea protein 870H | 5.6 |
| Salt | 0.7 |
| Extra Virgin Olive Oil (from Bertolli) | 2.2 |
| Xanthan gum (from Jungbunzlauer) | 0.2 |
| — | 100.0 |

The process for making a food wrap is as follows. Place egg whites in container. In a separate container, blend all the dry ingredients. Add blended dry ingredients and olive oil to egg whites. Using a high-speed blender, blend mixture until smooth. Preheat a 6-inch diameter non-stick oven-able pan to 265° F. Spray pan lightly with vegetable spray. Set Rational 61E Combi Oven to 450° F., 60% steam, fan speed 2. Ladle 40 grams of wrap mixture into hot pan and spread batter as needed. Bake for 2 minutes. Remove pan from oven and place on cooling rack. Cool for 5-6 minutes at room temperature. Chill or freeze as desired.

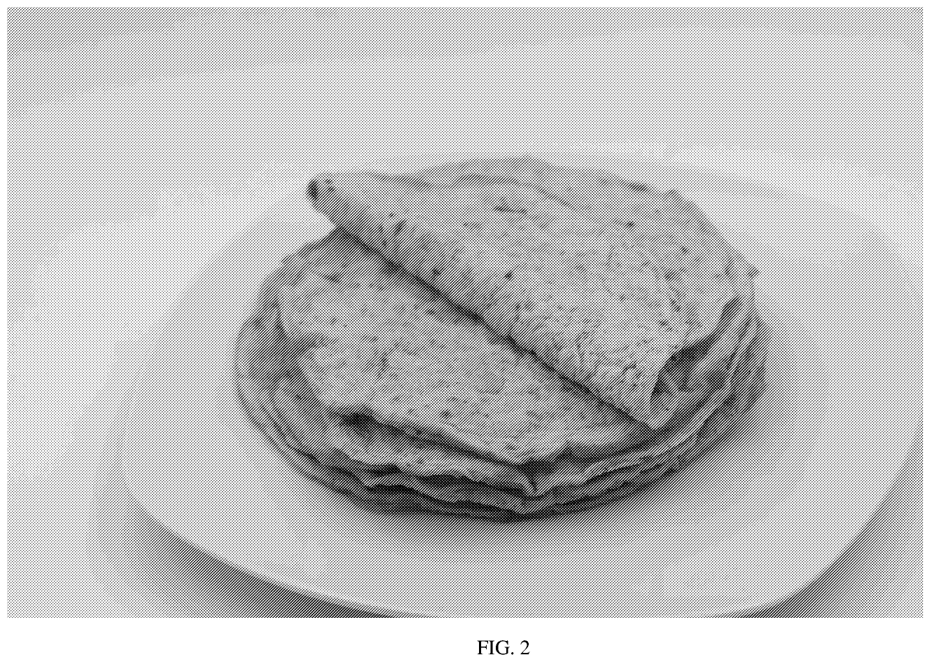

A red salsa flavor wrap was prepared by adding 120 g red salsa mix (from Supherb Foods) to 800 g base formula (FIG. 2). An Italian flavor wrap was prepared by adding 20 g Italian seasoning mix (from Supherb Foods) and 35 g pesto (from Supherb Foods) to 800 g base formula. These flavor ingredients were added with the olive oil to the egg whites in the above process.

### Example 2: Food Wrap Based on Multiple Non-Meat Protein Ingredients

In this example, a food wrap (i.e., edible food carrier), in particular a crepe-style food wrap, is prepared according to the base formula provided in Table 2 below.

TABLE 2
Base formula for food wrap

| Ingredient | Amount (%) |
|---|---|
| Egg whites (pasteurized liquid) | 69.95 |
| Cultured skim milk | 10.0 |
| Soybean Oil (Cargill) | 1.00 |
| Water | 10.00 |
| Quinoa Flour (Ardent Mills) | 8.50 |
| Salt | 0.45 |
| Xanthan Gum | 0.10 |
| Buckwheat Flour (Ardent Mills) | 1.00 |
| — | 100.00 |

The process for making a food wrap is as follows. Egg whites, water, oil, salt, xanthan gum are added to the mixer (Breddo), ingredients are mixed for 180 seconds. Mixture is pasteurized and pushed to second mixer (Breddo). Cultured dairy, quinoa flour, and buckwheat flour are added and mixed for 180 seconds. Product is dispensed on pans. The pan temperature range is from 260 degrees F. to 325 degrees F. Product is cooked in a dry heat oven for 1 minute to 1 minute and 30 seconds. Then product is cooked with 100% team for 1 minute to 1 minute and 30 seconds. Product is de-panned and frozen.

### Example 3: Food Wrap Based on Multiple Non-Meat Protein Ingredients

In this example, a food wrap (i.e., edible food carrier), in particular a crepe-style food wrap, is prepared according to the base formula provided in Table 3 below.

TABLE 3
Base formula for food wrap

| Ingredient | Amount (%) |
|---|---|
| Whole egg | 69.95 |
| Culture skim milk | 10.0 |
| Soybean Oil | 1.00 |
| Water | 10.00 |
| Quinoa Flour | 8.50 |
| Salt | 0.45 |
| Xanthan Gum | 0.10 |
| — | 100.00 |

The process for making a food wrap using the formula in Table 3 is the same as the process used for Example 2.

### Example 4: Omelet-Style Wrap

In this example, a food wrap (i.e., edible food carrier), in particular an omelet “roll-up” style wrap, is prepared according to the base formula provided in Table 4 below.

TABLE 4
Base formula for food wrap

| Ingredient | Amount (%) |
|---|---|
| Whole egg | 83.25 |
| Soybean Oil | 1.00 |
| Water | 15.00 |
| Guar/Carob Bean Gum | 0.150 |
| Salt | 0.30 |
| Creamgel 70001 (tapioca native starch, | 0.30 |
| Cargill) | |
| — | 100.00 |

The process for making a food wrap is as follows. Whole egg, water, oil, salt, xanthan gum, and starch are added to the mixer (Breddo), ingredients are mixed for 180 seconds. Mixture is pasteurized. Product is dispensed on pans. The pan temperature range is from 260 degrees F. to 325 degrees F. Product is cooked in a dry heat oven for 1 minute to 1 minute and 30 seconds. Then product is cooked with 100% team for 1 minute to 1 minute and 30 seconds. Product is de-panned and frozen.

### Example 5: Crepe-Style Wrap

In this example, a food wrap (i.e., edible food carrier), in particular a crepe-style wrap, is prepared according to the base formula provided in Table 5 below.

TABLE 5
Base formula for food wrap

| Ingredient | Amount (%) |
|---|---|
| Whole egg | 77.85 |
| Non-Fat Dried Milk | 2.00 |
| Soybean Oil | 1.50 |
| Water | 10.00 |
| Quinoa Flour | 7.00 |
| Salt | 0.45 |
| Xanthan Gum | 0.20 |
| Polartex 06732 (stabilized starch, Cargill) | 1.00 |
| — | 100.00 |

Whole egg, water, oil, nonfat dry milk, salt, xanthan gum, and Polartex 06732 are added to the mixer (Breddo), ingredients are mixed for 180 seconds. Mixture is pasteurized, and pushed to the particulate tanks, quinoa flour is added. Product is mixed and dispensed on pans. The pan temperature range is from 260 degrees F. to 325 degrees F. Product is cooked in a dry heat oven for 1 minute to 1 minute and 30 seconds. Then product is cooked with 100% team for 1 minute to 1 minute and 30 seconds. Product is de-panned and frozen.

### Example 6: Food Wrap Based on Egg Whites

In this example, a food wrap (i.e., edible food carrier) is prepared according to the base formula provided in Table 6 below.

TABLE 6
Base formula for food wrap

| Ingredient | Amount (%) |
|---|---|
| Whole Egg or Egg whites (Pasteurized liquid) | 87.70 |
| Water | 10.00 |
| Corn starch (Cargill) | 1.00 |
| Sea salt or Salt (Cargill) | 0.30 |
| Psyllium Fiber (Psyllium Labs) | 1.00 |
| — | 100.0 |

The process for making a food wrap is as follows. Place egg whites or whole eggs in container. In a separate container, blend all the dry ingredients. Add blended dry ingredients to whole eggs or egg whites. Using a high-speed blender, blend mixture until smooth. Preheat a 5-inch diameter non-stick oven-able pan to 265° F. Spray pan lightly with vegetable spray. Set Rational 61E Combi Oven to 450° F., 60% steam, fan speed 2. Ladle 40 grams of wrap mixture into hot pan and spread batter as needed. Bake for 2 minutes. Remove pan from oven and place on cooling rack. Cool for 5-6 minutes at room temperature. Chill or freeze as desired.

The food wrap made with formula of Table 6 is pliable, flexible, easy to roll, and has a comparable eating experience to a corn tortilla without the breakage.

What is claimed is:

1. A composition for making edible food carriers, comprising:
egg whites in an amount of at least 85% by weight;
one or more plant protein ingredients in an amount of at least 3% by weight;
vegetable oil;
and a stabilizer.

2. The composition of claim 2, wherein the one or more plant protein ingredients comprises pea protein.

3. The composition of claim 1, wherein the one or more plant protein ingredients comprises a pea protein isolate or concentrate having at least 70%, at least 75%, or at least 80% by weight pea protein.

4. The composition of claim 1, wherein the egg whites are present in an amount of at least 90% by weight.

5. The composition of claim 1, wherein the one or more plant protein ingredients are present in an amount of at least 4%, at least 5%, or at least 5.5% by weight.

6. A composition for making edible food carriers, comprising:
egg in an amount of at least 60% by weight;
one or more non-meat protein ingredients in an amount of at least 5% by weight;
vegetable oil;
and a stabilizer.

7-10. (canceled)

11. The composition of claim 1, wherein the one or more plant protein ingredients comprise pea protein, quinoa protein, buckwheat protein, or any combination thereof.

12. (canceled)

13. (canceled)

14. The composition of claim 1, wherein the vegetable oil comprises olive oil or soybean oil.

15. The composition of claim 1, wherein the vegetable oil is present in an amount of at least 0.5% by weight.

16. The composition of claim 1, wherein the stabilizer comprises xanthan gum.

17. (canceled)

18. The composition of claim 1, wherein the composition further comprises a native starch.

19. A composition for making edible food carriers, comprising:
egg in an amount of at least 80% by weight;
water;
starch;
salt; and
a stabilizer,
wherein the total carbohydrate content of the composition is less than 1.0%.

20. (canceled)

21. The composition of claim 19, wherein the egg is present in an amount of at least 85% by weight.

22. The composition of claim 19, wherein the egg consists essentially of egg whites.

23. The composition of claim 19, wherein the starch comprises corn starch.

24. The composition of claim 19, wherein the starch is present in an amount of 0.5 to 1.5% by weight.

25. The composition of claim 19, wherein the salt is present in an amount of 0.1 to 1.0% by weight.

26. The composition of claim 19, wherein the stabilizer comprises psyllium fiber.

27. The composition of claim 19, wherein the stabilizer is present in an amount of 0.1 to 2.0% by weight.

28. The composition of claim 1, wherein the composition further comprises one or more flavor ingredients.

29. An edible food carrier comprising the composition of claim 1.

30. The composition or food carrier of claim 1, wherein the composition or food carrier is gluten-free.
